(19) United States
(12) Patent Application Publication
(10) Pub. No.: US 2025/0010176 A1
(43) Pub. Date: Jan. 9, 2025

(54) CLAW MACHINE AND ARCADE GAMING SYSTEM USING THE CLAW MACHINE

(71) Applicant: PAOKAl ELECTRONIC ENTERPRISE CO., LTD., Kaohsiung City (TW)

(72) Inventor: Ming-Shan WEI, Kaohsiung City (TW)

(73) Assignee: PAOKAl ELECTRONIC ENTERPRISE CO., LTD., Kaohsiung City (TW)

(21) Appl. No.: 18/486,820

(22) Filed: Oct. 13, 2023

(30) Foreign Application Priority Data
Jul. 6, 2023 (TW) 112125302

(51) Int. Cl. A63F 9/30; G07F 17/32

(52) U.S. Cl. CPC A63F 9/30; G07F 17/3209; G07F 17/3211; G07F 17/3223; G07F 17/3227; G07F 17/3253; G07F 17/3267; G07F 17/3272; G07F 17/3297; A63F 2250/144

(57) ABSTRACT

A claw machine includes a machine body, a plurality of target objects, a shuffling unit and a controlling unit. The machine body includes a cabinet that defines an inner space, a claw mechanism, and a prize outlet for providing a prize object. The target objects are disposed in the inner space, and each contains first game information. The shuffling unit includes a shuffling mechanism that is configured to, when interacting with one of the target objects, generate and output second game information. The controlling unit includes a sensing component for detecting the first game information from the one of the target objects, a receiving component connected to the shuffling mechanism for receiving the second game information therefrom, and a processor configured to determine whether to control the prize outlet to provide a prize object based on the first game information and the second game information received during a game.

### CROSS-REFERENCE TO RELATED APPLICATION

This application claims priority to Taiwanese Invention Patent Application No. 112125302, filed on Jul. 6, 2023, and incorporated by reference herein in its entirety.

### FIELD

The disclosure relates to a claw machine, and an arcade gaming system that employs the claw machine.

### BACKGROUND

FIG. 1 illustrates a conventional arcade game machine, which may be a claw machine 1. The claw machine 1 includes a cabinet 10 that defines an inner space 100, a claw mechanism 11 that is disposed on a ceiling of the cabinet 10, and a controller 12 that controls movement of the claw mechanism 11 (e.g., a joystick to move the claw mechanism 11, and a button to control the claw mechanism 11 to move down and to attempt to grab an object below). In use, the inner space 100 may be filled with a plurality of objects as prizes, and a player who drops a coin or a token may operate the controller 12 to attempt to grab one of the prizes in the inner space 100.

Recently, arcades with a plurality of claw machines 1 have become popular. The claw machines 1 in a same arcade may be rented out to and run by different owners, who may individually decide the kind of objects to be provided in the inner space 100, the level of grabbing strength of the claw mechanism 11, and an amount of prize-guarantee spending, which allows the user to obtain the prize when the user has spent the amount of money without having successfully grabbed the prize using the claw mechanism 11.

It is noted that currently a game of the claw machine 1 typically involves operating the joystick to move the claw mechanism 11, and pressing the button to control the claw mechanism 11 to move down and to attempt to grab the object below. After an extended period of time, the game may become repetitive and therefore may lose appeal to the players.

### SUMMARY

Therefore, one object of the disclosure is to provide a claw machine that can provide a more variety of gameplay over the conventional claw machines.

According to one embodiment of the disclosure, the claw machine includes a machine body, a plurality of target objects, a shuffling unit, and a controlling unit.

The machine body includes a cabinet that defines an inner space therein, and that includes a top wall, a claw mechanism that is disposed at the top wall of the cabinet, an operating interface that is connected to the claw mechanism and that is operable to control operations of the claw mechanism, and a prize outlet that is disposed on the cabinet for providing a prize object.

The plurality of target objects are placed in the inner space of the cabinet. Each of the plurality of target objects contains a piece of first game information and having a size and weight that can be grabbed, carried and dropped by the claw mechanism.

The shuffling unit is disposed in the inner space of the cabinet, and includes: a tube that defines a shuffling space therein, and that is formed with a top opening which enables one of the target objects to pass therethrough into the tube; and a bottom opening which is spatially connected to the inner space of the cabinet.

The shuffling mechanism is disposed in the shuffling space, and is configured to, when interacting with one of the target objects, generate and output a piece of second game information.

The controlling unit includes a sensing component that is disposed near the bottom opening for detecting the piece of first game information from the one of the target objects, a receiving component that is connected to the shuffling mechanism for receiving the piece of second game information therefrom, and a processor that is connected to the sensing component and the receiving component for receiving the piece of first game information and the piece of second game information, respectively.

The processor is configured to determine a result of a game based on the piece of first game information and the piece of second game information received during the game, and determine whether to control the prize outlet to provide at least one prize object based on the result of the game.

Another object of the disclosure is to provide an arcade gaming system that employs the above-mentioned claw machines, and to provide a multi-player game for a plurality of player to participate.

According to one embodiment of the disclosure, the arcade gaming system includes a plurality of the above-mentioned claw machines, a shared display screen, and a main server connected to each of the plurality of claw machines and the shared display screen.

The main server controls the shared display screen to display information related to the pieces of first game information and the pieces of second game information received by the processors of the plurality of claw machines during a multi-player game.

The main server determines a result of the multi-player game based on the pieces of first game information and the pieces of second game information received by the processors of the plurality of claw machines

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 illustrates a conventional claw machine.

FIG. 2 is a perspective view of a claw machine according to one embodiment of the disclosure.

FIG. 3 illustrates an exemplary target object according to one embodiment of the disclosure.

FIG. 4 illustrates an exemplary shuffling unit according to one embodiment of the disclosure.

FIG. 5 illustrates an exemplary progress screen that may be displayed by a display screen during a game according to one embodiment of the disclosure.

FIG. 6 illustrates another exemplary progress screen that may be displayed by the display screen during the game according to one embodiment of the disclosure.

FIG. 7 illustrates an arcade gaming system according to one embodiment of the disclosure.

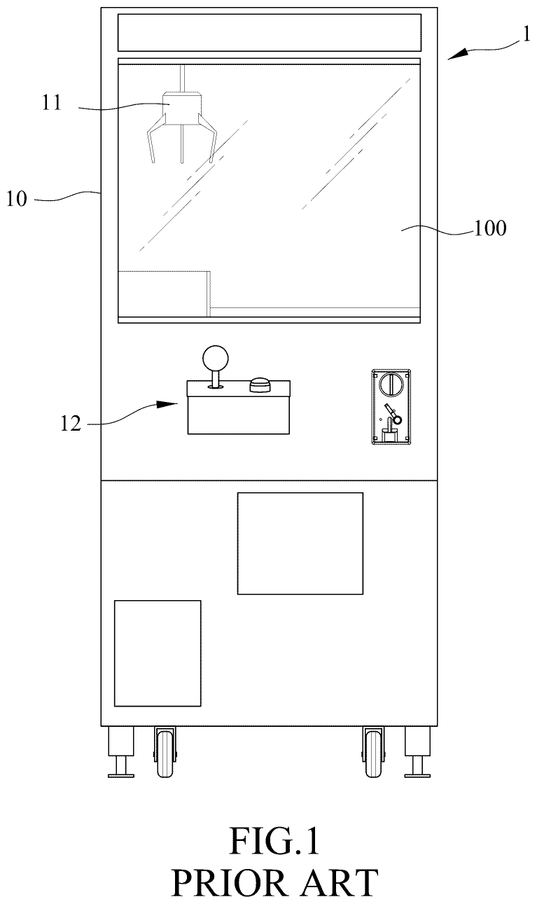

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

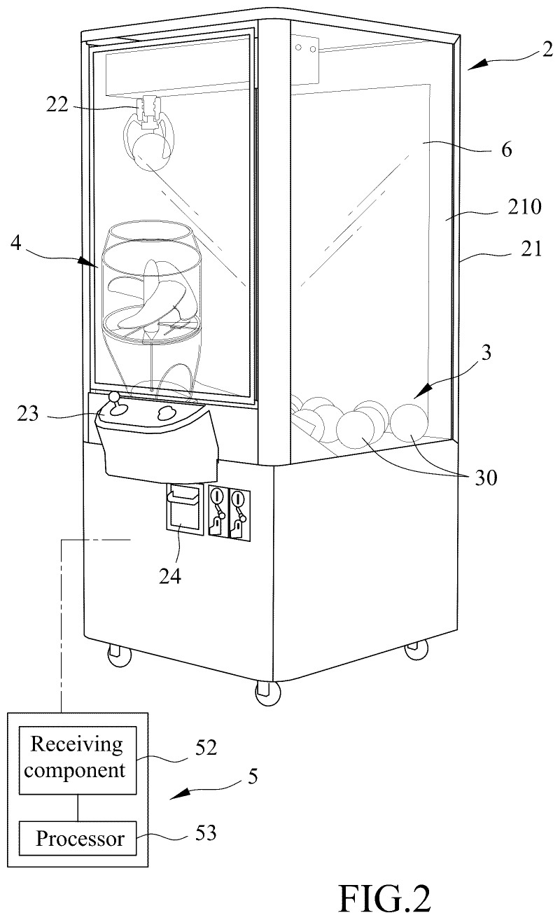

FIG. 2 is a perspective view of a claw machine 200 according to one embodiment of the disclosure. In this embodiment, the claw machine 200 includes a machine body 2, a plurality of target objects 30, a shuffling unit 4, a controlling unit 5 and a display screen 6.

The machine body 2 includes a cabinet 21 that defines an inner space 210 therein, a claw mechanism 22 that is disposed at a top wall of the cabinet 21, an operating interface 23 that is connected to the claw mechanism 22, a prize outlet 24 that is disposed on the cabinet 21, and a coin slot 25 that is disposed on the cabinet 21.

The operating interface 23 is operable to control operations of the claw mechanism 22. Specifically, in this embodiment, the operating interface 23 is embodied using a joystick that controls movement of the claw mechanism 22 and a button to control the claw mechanism 22 to move down and to attempt to grab an object below.

The prize outlet 24 is for providing a prize object. Specifically, in this embodiment, the prize outlet 24 may be have an opening that is formed in the cabinet 21, and a passage that is spatially connected to an inner stash (not depicted in the drawings) that stores a plurality of prize objects (e.g., arcade tickets, pinballs, tokens, etc.). In use, the prize objects may be driven out to be provided to a player via the prize outlet 24, and since the operations of the prize outlet 24 are well known in the related art, details thereof are omitted herein for the sake of brevity. It is noted that in other embodiments, the prize outlet 24 may have other shapes or components so as to be capable of providing the prize objects to a player.

The coin slot 25 is for a player to drop a coin or a token therein so as to trigger the start of a game to be played using the claw machine 200. It is noted that the operations associated with the coin slot 25 are well known in the related art, so details thereof are omitted herein for the sake of brevity.

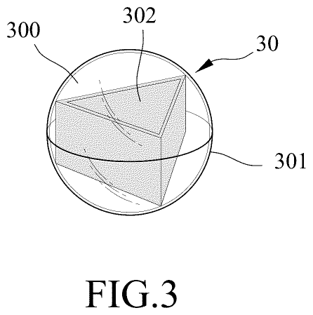

The plurality of target objects 30 are placed in the inner space 210 of the cabinet 21, and may be grabbed by the claw mechanism 22 placed above. FIG. 3 illustrates an exemplary target object 30 according to one embodiment of the disclosure. In this embodiment, the target object 30 is sphere-shaped, and includes a shell 301 that defines a hollow chamber 300, and an information-bearing component 302 that is disposed in the hollow chamber 300. The shell 301 may be formed using a transparent material, such that the information-bearing component 302 can be seen by the player. The information-bearing component 302 may have a tag (e.g., a radio-frequency identification (RFID) tag) thereon that can be read by a tag reader, and may have an appearance that indicates a piece of first game information associated with the target object 30. Additionally, the tag of the information-bearing component 302 of the target object 30 may contain the piece of first game information or information that corresponds with the piece of first game information.

In this embodiment, the piece of first game information may be a color of the information-bearing component 302 (e.g., red), and the tag may contain a color code that matches the color of the information-bearing component 302. In embodiments, the information-bearing components 302 of the target objects 30 may have different colors, and the tag on each of the target objects 30 may contain a respective color code to match the color of the information-bearing component 302.

In use, each of the target objects 30 is formed to have a size and weight that can be grabbed, carried and dropped by the claw mechanism 22.

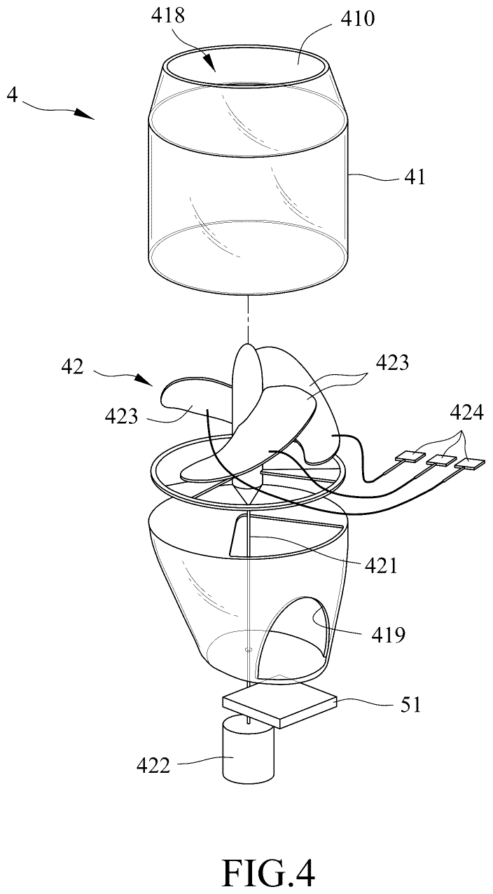

FIG. 4 illustrates an exemplary shuffling unit 4 according to one embodiment of the disclosure. In this embodiment, the shuffling unit 4 is disposed in the inner space 210 of the cabinet 21, and includes a tube 41 that defines a shuffling space 410 therein, and a shuffling mechanism 42 that is disposed in the shuffling space 410.

The tube 41 is formed with a top opening 418 that enables a target object 30 to pass therethrough and go into the tube 41, and a bottom opening 419 that is spatially connected to the inner space 210 of the cabinet 21. That is to say, the bottom opening 419 enables the target object 30 in the tube 41 to leave the tube 41 and return to the inner space 210 of the cabinet 21. In this manner, one target object 30 in the inner space 210 may be grabbed by the claw mechanism 22, dropped into the tube 41 via the top opening 418, and return to the inner space 210 via the bottom opening 419. As such, the number of target objects 30 remains the same after games are played.

The shuffling mechanism 42 is disposed in the tube 41, and is configured to, when interacting with one of the target objects 30, generate and output a piece of second game information.

Specifically, in the embodiment of FIG. 4, the shuffling mechanism 42 is disposed between the top opening 418 and the bottom opening 419, and includes a rotate axle 421, a motor 422 connected to the rotate axle 421, a plurality of fan blades 423 that are connected to the rotate axle 421, and a plurality of detecting components 424 that correspond with the fan blades 423, respectively. In this embodiment, three fan blades 423 are present.

In use, when the motor 422 of the shuffling mechanism 42 is activated, the rotate axle 421 is actuated to rotate (clockwise or counterclockwise), and to drive the fan blades 423 to rotate along. When one of the fan blades 423 is in contact with a target object 30, the corresponding one of the detecting components 424 detects the contact, and outputs a piece of second game information associated with the one of the fan blades 423. In some embodiments, each of the detecting components 424 may be implemented to include a contact sensor and a wireless transmitter connected to the contact senor. The contact sensor may include a piezoelectric sensor or another suitable sensor that reacts to pressure or force and outputs an electrical signal correspondingly. The wireless transmitter, in response to receipt of the electrical signal, outputs the piece of second game information corresponding to the one of the fan blades 423 that is in contact with the target object 30. The wireless transmitter of each of the detecting components may include one or more of a radio-frequency integrated circuit (RFIC), a short-range wireless communication module supporting a short-range wireless communication network using a wireless technology of Bluetooth® and/or Wi-Fi, etc.

In this embodiment, the piece of second game information may also include a color code, and each of the fan blades 423 is associated with a specific color indicated by the color code (i.e., a specific piece of second game information). In some cases, each of the fan blades 423 may be made to have a color identical to the specific color indicated by the color code (e.g., red, blue and yellow).

The plurality of the target objects 30 can be categorized into a number of subsets. Each of the subsets is associated with a specific color, the number of subsets is identical to the number of fan blades 423 (three in this embodiment) and the colors associated with the fan blades 423 are the same as the colors associated with the target objects 30 (e.g., red, yellow and blue, but other colors may be employed as well). For each of the subsets, the target objects 30 in the subset have one of the specific colors. That is to say, in the point of view of the player, three subsets of target objects 30, respectively with the colors of red, yellow and blue, are present in the inner space 210.

The controlling unit 5 includes a sensing component 51 disposed near the bottom opening 419 for detecting the tag on the information-bearing component 302 of a target object 30 travelling through the bottom opening 419 and for obtaining the piece of first game information therefrom, a receiving component 52 connected to the detecting components 424 for receiving the piece of second game information therefrom, and a processor 53 connected to the sensing component 51 and the receiving component 52 for receiving the piece of first game information and the piece of second game information.

In this embodiment, the sensing component 51 may include an RFID reader to obtain the piece of first game information contained in the tag on the information-bearing component 302. In some embodiments, the information-bearing components 302 of the target objects 30 may include light-emitting diodes (LEDs) that are configured to emit light of different colors, and the sensing component 51 may be configured to detect the light emitted by the information-bearing component 302 of the target object 30 travelling through the bottom opening 419 so as to determine the first piece of game information associated with the target object 30.

The receiving component 52 may include one or more of a radio-frequency integrated circuit (RFIC), a short-range wireless communication module supporting a short-range wireless communication network using a wireless technology of Bluetooth® and/or Wi-Fi, etc. The processor 53 may include, but is not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

In use, prior to a game, the claw mechanism 22 is located at an initial position above the top opening 418. When a player starts a game by dropping a coin through the coin slot 25, the game starts, and the claw mechanism 22 becomes operable by the operating interface 23. After the player controls the claw mechanism 22 using the joystick to move above one of the target objects 30, he/she may press the button to control the claw mechanism 22 to move down and grab the one of the target objects 30. Afterward, the claw mechanism 22 carrying the grabbed target objects 30 automatically moves back to the initial position, and drops the one of the target objects 30 down into the tube 41 via the top opening 418.

Prior to the target object 30 being dropped into the tube 41, the motor 422 of the shuffling mechanism 42 may be activated, so as to actuate the rotate axle 421 to rotate (clockwise or counterclockwise), and to drive the fan blades 423 to rotate with the rotate axle 421. As the target object 30 travels in the tube 41, one of the fan blades 423 may come into contact with the target object 30. As a result, the corresponding one of the detecting components 424 detects the contact and outputs the corresponding second piece of game information to the receiving component 52. Afterward, the target object 30 continues to drop and eventually moves out of the tube 41 through the bottom opening 419, and the sensing component 51 would then obtain the piece of first game information associated with the target object 30. The processor 53 then receives the piece of first game information and the piece of second game information from the sensing component 51 and the receiving component 52, respectively.

Based on different settings of the game, one or more objectives based on the first game information and the second game information may be proposed for the player to achieve in order to win the prize.

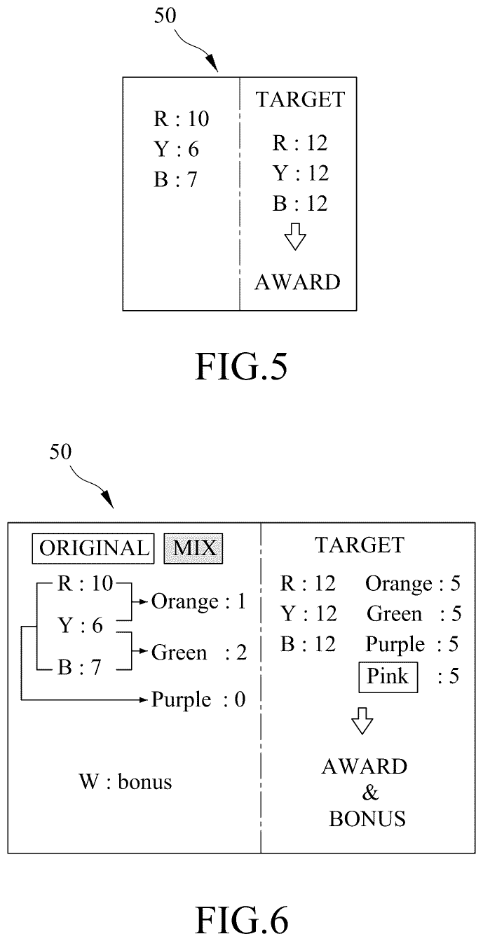

In embodiments, the display screen 6 is controlled by the processor 53 to display information related to the piece(s) of first game information and the piece(s) of second game information received thus far, if any, by the processor 53 during the game. For example, FIG. 5 illustrates an exemplary progress screen 50 that may be displayed by the display screen 6 during the game according to one embodiment of the disclosure.

The progress screen 50 includes a first section that displays a current progress associated with the piece(s) of first game information and the piece of second game information received thus far, if any, by the processor 53 during the game, and a second section that lists a plurality of objectives. In the embodiment of FIG. 5, three objectives are present, respectively being “twelve occurrences of red,” “twelve occurrences of yellow” and “twelve occurrences of blue,” and all three objectives need to be achieved in order to obtain an associated prize. The processor 53 may determine the progress of the game using the piece(s) of first game information and the piece(s) of second game information thus received, if any.

In detail, when one of the target objects 30 comes into contact with one of the fan blades 423 that is associated with the piece of second game information of “red,” the processor 53 may accumulate an occurrence of red by one. When one of the target objects 30 that is associated with the piece of first game information of “red” travels through the bottom opening 419, the processor 53 may accumulate an occurrence of red by one. As such, the player may be compelled to try to control the claw mechanism 22 to grab target objects 30 that have different colors and that may be more difficult to grab.

In some embodiments, a time limit for the player to achieve all objectives may be in place. In some embodiments, an attempt limit (e.g., a number of times the button is allowed to be pressed) for the player to achieve all objectives may be in place.

In some embodiments, the processor 53 may determine the progress of the game using only the piece(s) of first game information thus received, if any, or only the piece(s) of second game information thus received, if any. For example, in some cases, the processor 53 may consider only the first game information, and the player is required to grab target objects 30 with specific colors to achieve the objectives. Alternatively, the processor 53 may consider only the second game information, and the player is required to make target objects 30 come into contact with the fan blades 423 with the specific colors to achieve the objectives. In some embodiments, the rule may change during the game. For example, in the embodiment of FIG. 5, after two of the three objectives have been achieved, the processor 53 may switch to only considering the first game information. In another example, in the embodiment of FIG. 5, for each of the three objectives, when the objective is about to be achieved (i.e., 11 occurrences accumulated), the processor 53 may switch to only considering the first game information such that the player is required to grab a target object 30 with the associated color in order to achieve the objective.

FIG. 6 illustrates another exemplary progress screen 50 that may be displayed by the display screen 6 during the game according to one embodiment of the disclosure. In this embodiment, in addition to the above-described playing mode (known as an “original mode”), another mode (known as a “mix mode”) is available.

In the mix mode, for each target object 30 dropped into the tube 41, the associated piece of first game information and the piece of second game information received by the processor 53 may be processed as a combination, and the objectives may be designed based on specific combinations of the pieces of first and second game information. As such, the processor 53 may determine the result of the game based on the combination(s) of the piece(s) of first game information and the piece(s) of second game information thus received, if any.

In the embodiment of FIG. 6, when the player chooses to play in the mix mode, additional objectives based on combinations of colors may be present. For example, the objectives may include an occurrence of “orange,” which is a combination of the color red and the color yellow. In use, the occurrence of “orange” may be achieved by grabbing a target object 30 with one of the red color and the yellow color, and dropping the target object 30 to contact one of the fan blades 423 with the other one of the red color and the yellow color. Similarly, an occurrence of “green” may be achieved by grabbing a target object 30 with one of the blue color and the yellow color, and dropping the target object 30 to contact one of the fan blades 423 with the other one of the blue color and the yellow color. Likewise, an occurrence of “purple” may be achieved by grabbing a target object 30 with one of the blue color and the red color, and dropping the target object 30 to contact one of the fan blades 423 with the other one of the blue color and the red color.

In some embodiments, some additional colors may be employed to associate with one of the piece of first game information and the piece of second game information, and additional objectives may be created. For example, the shuffling mechanism 42 may include a fourth fan blade 423 which is associated with the white color, and the objectives may further include an occurrence of “pink,” which may be achieved by grabbing a target object 30 with a red color, and dropping the target object 30 to contact the fourth fan blade 423 with the white color. Alternatively, the shuffling mechanism 42 may include three fan blades 423 with the red color, the yellow color and the blue color, respectively, and additional target objects 30 with the white color may be put in the inner space 210. As such, the occurrence of “pink” may be achieved by grabbing a target object 30 with the white color, and dropping the target object 30 to contact the fan blade 423 with the red color.

In any of the above settings, after a game is finished (i.e., a preset time has elapsed or a preset number of attempts of pushing the button has been reached, or after the objectives are all achieved), the processor 53 is configured to determine the result of the game (i.e., whether the player has achieved all the objectives) based on the piece(s) of first game information and the piece(s) of second game information received, if any, during the game, and whether to control the prize outlet 24 to provide at least one prize object based on the result of the game.

After the objectives have been achieved, the processor 53 may control the prize outlet 24 to deliver the prize to the player. Based on the different difficulties of the objectives, an amount of the prize may also be different. For example, in a case where the prize is arcade tickets, when an objective involving occurrence of “pink” has been achieved, additional arcade tickets may be delivered to the player, compared to the case where the objective involving occurrence of “pink” was never achieved during the game.

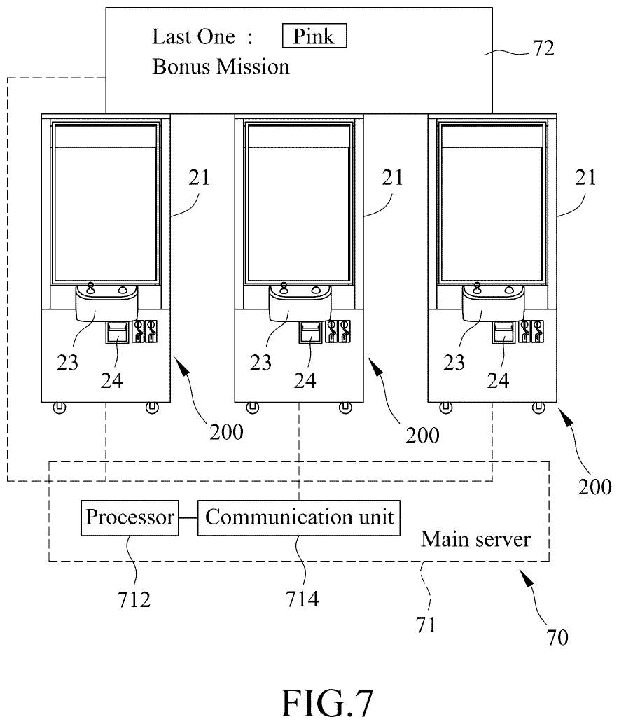

FIG. 7 illustrates an arcade gaming system 70 according to one embodiment of the disclosure. In the embodiment, the arcade gaming system 70 includes a plurality of claw machines 200 (three are present in FIG. 7), a main server 71, and a shared display screen 72.

Each of the claw machines 200 may be similar to that described in the previous embodiments and shown in FIGS. 2 to 4. The main server 71 includes a processor 712 and a communication unit 714. The processor 712 may include one or more of a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc. The main server 71 is configured to communicate with each of the claw machines 200 and the shared display screen 72 via the communication unit 714. The communication unit 714 is connected to the processor 712, and may include one or more of a network interface controller (NIC), a radio-frequency integrated circuit (RFIC), a short-range wireless communication module supporting a short-range wireless communication network using a wireless technology of Bluetooth® and/or Wi-Fi, etc.

In use, the arcade gaming system 70 may enable two or more of the claw machines 200 to be simultaneously operated by different players, so as to initiate a multi-player game. In the multi-player game, a number of different playing modes may be provided. For example, a competition mode may be provided, where the players are separately assigned a same set of objectives, and the players compete to achieve the objectives in the shortest time or with the fewest attempts. During the game in the competition mode, the progress of each player may be displayed on the shared display screen 72, enabling all players to view the relevant information. That is to say, the shared display screen 72 is controlled by the processor 712 of the main server 71 to display information related to the piece(s) of first game information and the piece(s) of second game information received, if any, by the processor 53 (see FIG. 2) of each of the plurality of claw machines 200 during the game. In the embodiment of FIG. 7, the shared display screen 72 may be further controlled by the processor 712 of the main server 71 to display additional information such as the piece(s) of first game information and the piece(s) of second game information that is the most recently received (e.g., in the form of the term “Last One”).

After a multi-player game in the competition mode is over, additional prize may be delivered to the player who achieved the objectives in the shortest time or with the fewest attempts. That is to say, the processor 712 of the main server 71 determines a result of the multi-player game in the competition mode based on the piece(s) of first game information and the piece(s) of second game information received, if any, by the processor 53 of each of the plurality of claw machines 200. The result of the multi-player game in the competition mode includes a most valuable player (MVP), which may be a winner of the multi-player game in the competition mode. Then, based on the result of the multi-player game in the competition mode, the processor 712 may control the processor 53 of each of the claw machines 200 to deliver a specific amount of prize to the corresponding player, and control the processor 53 of one of the claw machines 200 that corresponds to the winner, to deliver, via the prize outlet 24, a bonus prize to the player who wins the game, but this disclosure is not limited to such.

Alternatively, a cooperative mode may be provided, where a set of shared objectives is given, and all the players cooperate to achieve the set of shared objectives. During the game in the cooperative mode, the progress of achieving the set of shared objectives may be displayed on the shared display screen 72, enabling all players to view the relevant information. In the cooperative mode, a same prize may be delivered to each of the players who participated in the game. In some cases, an additional prize may be delivered to the player whose action achieved a last remaining objective of the set of shared objectives, thereby fulfilling the set of shared objectives (an action also known as “last hit”). That is to say, the processor 712 of the main server 71 determines a result of the multi-player game in the cooperative mode based on the piece(s) of first game information and the piece(s) of second game information received, if any, by the processor 53 of each of the plurality of claw machines 200. The result of the multi-player game in the cooperative mode includes a most valuable player (MVP), which may be the player who performs the last hit. Then, based on the result of the multi-player game in the cooperative mode, the processor 712 may control the processor 53 of each of the claw machines 200 to deliver a specific amount of prize to the corresponding player, and control the processor 53 of one of the claw machines 200 that corresponds to the MVP to deliver a bonus prize to the player who performs the last hit, but the disclosure is not limited to such. In some embodiments, after a set of shared objectives is completed, a bonus mission may be provided which involves additional prize.

To sum up, embodiments of the disclosure provide a claw machine and an arcade gaming system that employs the claw machine. In the claw machine, the shuffling unit is introduced, and after a target object is grabbed by the claw mechanism and dropped into the shuffling unit, a corresponding piece of first game information (which is associated with the target object) and a piece of second game information (which is associated with an interaction between the target object and a fan blade in the shuffling unit) may be obtained. Using the first game information and the second game information, several new gameplays may be developed as described in the above embodiments, providing different experiences to the player. For the arcade gaming system, a plurality of the claw machines are employed to provide gameplay for a plurality of players, and the gameplay includes, but not limited to, a competition mode and a cooperative mode. In this manner, the claw machine and the arcade gaming system offer a number of gameplay options that are not available using the conventional claw machines.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A claw machine comprising:
a machine body including
a cabinet that defines an inner space therein, and that includes a top wall,
a claw mechanism that is disposed at the top wall of the cabinet,
an operating interface that is connected to the claw mechanism and that is operable to control operations of the claw mechanism, and
a prize outlet that is disposed on the cabinet for providing a prize object;
a plurality of target objects placed in the inner space of the cabinet, each of the plurality of target objects containing a piece of first game information and having a size and weight that can be grabbed, carried and dropped by the claw mechanism;
a shuffling unit disposed in the inner space of the cabinet, and including
a tube that defines a shuffling space therein, and that is formed with a top opening which enables one of the target objects to pass therethrough into the tube, and a bottom opening which is spatially connected to the inner space of the cabinet, and
a shuffling mechanism that is disposed in the shuffling space, and that is configured to, when interacting with one of the target objects, generate and output a piece of second game information; and
a controlling unit including
a sensing component that is disposed near the bottom opening for detecting the piece of first game information from the one of the target objects,
a receiving component that is connected to the shuffling mechanism for receiving the piece of second game information therefrom, and
a processor that is connected to the sensing component and the receiving component for receiving the piece of first game information and the piece of second game information, respectively, and that is configured to determine a result of a game based on the piece of first game information and the piece of second game information received during the game, and determine whether to control the prize outlet to provide at least one prize object based on the result of the game.

2. The claw machine as claimed in claim 1, wherein each of the target objects includes:
a shell that defines a hollow chamber; and
an information-bearing component that is disposed in the hollow chamber and that contains the piece of first game information.

3. The claw machine as claimed in claim 2, wherein, for each of the target objects, the shell is formed using a transparent material, and the piece of first game information is a color of the information-bearing component.

4. The claw machine as claimed in claim 2, wherein, for each of the target objects, the information-bearing component includes a radio-frequency identification (RFID) tag, and the sensing component includes an RFID reader.

5. The claw machine as claimed in claim 1, wherein each of the piece of first game information and the piece of second game information is related to a color.

6. The claw machine as claimed in claim 5, wherein the processor is configured to determine the result of the game based on a combination of the piece of first game information and the piece of second game information received during the game.

7. The claw machine as claimed in claim 1, wherein the shuffling mechanism includes:
a rotate axle;
a motor that is connected to the rotate axle for driving the rotate axle to rotate;
a plurality of fan blades that are driven by the rotate axle to rotate, each of the fan blades being associated with a specific piece of second game information; and
a plurality of detecting components that correspond with the fan blades, respectively;
when the one of the target objects comes into contact with one of the plurality of fan blades, the corresponding one of the detecting components detects the contact, and outputs the piece of second game information associated with the one of the fan blades.

8. The claw machine as claimed in claim 1, further comprising a display screen that is controlled by the processor to display information related to the piece of first game information and the piece of second game information received by the processor during the game.

9. An arcade gaming system comprising:
a plurality of claw machines as claimed in claim 1;
a shared display screen; and
a main server connected to each of the plurality of claw machines and the shared display screen, the main server controlling the shared display screen to display information related to the pieces of first game information and the pieces of second game information received by the processors of the plurality of claw machines during a multi-player game.

10. The arcade gaming system as claimed in claim 9, wherein the main server determines a result of the multi-player game based on the pieces of first game information and the pieces of second game information received by the processors of the plurality of claw machines, and controls the prize outlet of one of the claw machines to deliver a bonus prize object.
